(19) United States
(12) Patent Application Publication
(10) Pub. No.: US 2018/0009095 A1
(43) Pub. Date: Jan. 11, 2018

(54) SCRATCH-PROOF PAIR OF PLIERS

(71) Applicant: Chuang Lion Industry Co., Ltd., Taichung (TW)

(72) Inventor: Nian-Hao Liao, Taichung (TW)

(21) Appl. No.: 15/204,581

(22) Filed: Jul. 7, 2016

(51) Int. Cl. B25B 27/00; B25B 7/02

(52) U.S. Cl. CPC B25B 27/0078; B25B 7/02

(57) ABSTRACT

A scratch-proof pair of pliers includes two operative units and a protective cap. The first operative unit includes a first catch formed near an end. The first catch is adapted for engagement with a portion of a weight. The second operative unit includes a second catch formed near an end. The second catch is adapted for engagement with another portion of the weight. The protective cap includes a first end, a second end, a lower portion formed between the first and second ends, and an entrance made in the second end. The protective cap further includes an opening with a portion made in the first end and another portion made in the lower portion. The protective cap is provided on the end of the first operative unit while the catch of the first operative unit is exposed via the opening.

### BACKGROUND OF INVENTION

### 1. Field of Invention

The present invention relates to weights for wheels of vehicles and, more particularly, to a scratch-proof pair of pliers.

### 2. Related Prior Art

Weights are attached to rims of wheels of vehicles to keep the wheels in balance because unbalanced wheels vibrate when rolling and such vibration gets worse as the vehicles go faster. Such vibration makes drivers and/or passengers uncomfortable. Moreover, such vibration causes the vehicles to rattle and could therefore endanger the drivers and/or passengers. Therefore, every wheel must be spun and tested to find points in need of weights to reduce undesired vibration immediately after a new tire is attached to the rim thereof.

Weights are attached to rims by hooking or adhering. U.S. Pat. No. 9,044,844 discloses a pair of pliers 10 for removing hooking-type weights from rims. The pair of pliers 10 includes a first member 12 pivotally connected to a second member 22. The first member 12 includes a weight removal hook 18. A rim protector cap 40 that is made of nylon is provided on a tip 42 formed on the second member 22. The members 12 and 22 are closed or opened to move the weight removal hook 18 toward or from the rim protector cap 40 in operation. The rim protector cap 40 is placed against a rim to facilitate insertion of the weight removal hook 18 in a gap between the rim and a tire. The rim protector cap 40 is made with a rounded profile to protect the rim from scratching. However, the weight removable hook 18 might damage the rim in use.

Taiwanese Patent M505385 discloses a multi-functional pair of pliers for removing adhering-type weights from rims. The pair of pliers includes a first operative unit 20 pivotally connected to a second operative unit 30. The first operative unit 20 includes a catch 26 while the second operative unit 30 includes a catch 36. The operative elements 20 and 30 are closed or opened to move the catch 26 toward or from the catch 36 in operation. A soft layer 62 is provided on the catch 26 to protect a rim from scratching in operation. However, the catch 36 might damage the rim in operation.

The present invention is therefore intended to obviate or at least alleviate the problems encountered in prior art.

### SUMMARY OF INVENTION

It is the primary objective of the present invention to provide a scratch-proof pair of pliers.

To achieve the foregoing objective, the scratch-proof pair of pliers includes two operative units and a protective cap. The first operative unit includes a first catch formed near an end. The first catch is adapted for engagement with a portion of a weight. The second operative unit includes a second catch formed near an end. The second catch is adapted for engagement with another portion of the weight. The protective cap includes a first end, a second end, a lower portion formed between the first and second ends, and an entrance made in the second end. The protective cap further includes an opening with a portion made in the first end and another portion made in the lower portion. The protective cap is provided on the end of the first operative unit while the catch of the first operative unit is exposed via the opening.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a pair of pliers according to the preferred embodiment of the present invention;

FIG. 2 is an exploded view of a rim-protecting assembly used in the pair of pliers shown in FIG. 1;

FIG. 3 is a cross-sectional view of a first protective cap of the rim-protecting assembly shown in FIG. 1;

FIG. 4 is a side view of the pair of pliers shown in FIG. 1;

FIG. 5 is a side view of the pair of pliers in another position than shown in FIG. 4;

FIG. 6 is a side view of the pair of pliers in another position than shown in FIG. 5; and

FIG. 7 is a cross-sectional view of a wheel and the pair of pliers shown in FIG. 1.

### DETAILED DESCRIPTION OF PREFERRED EMBODIMENT

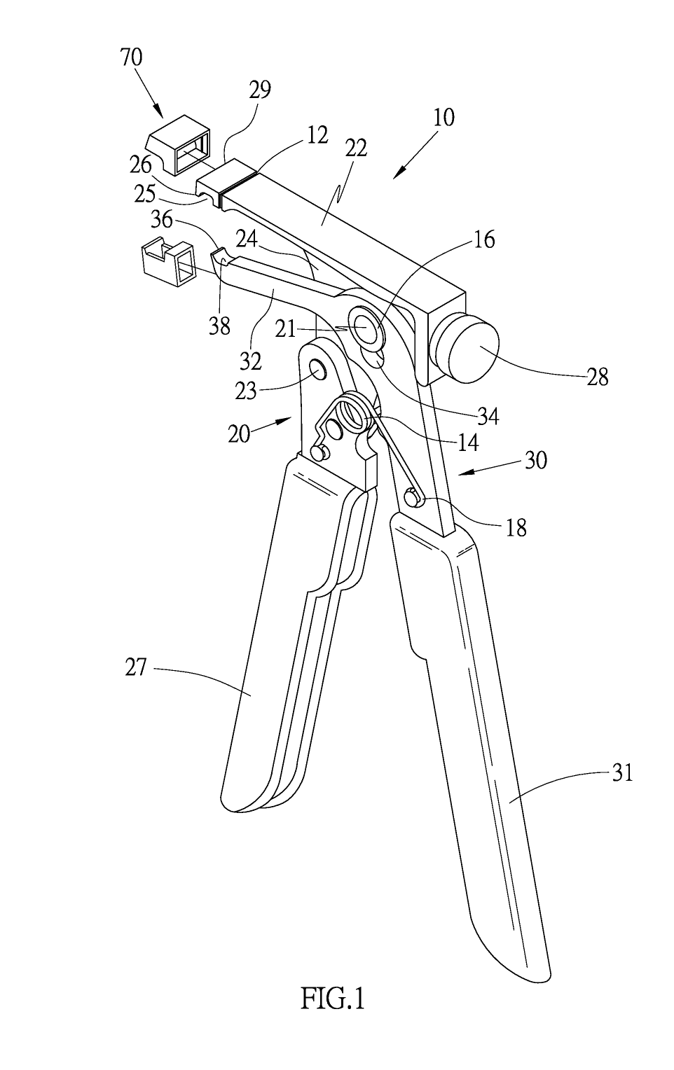

Referring to FIG. 1, a scratch-proof pair of pliers 10 includes a first operative unit 20, a second operative unit 30 and a rim-protecting assembly 70 according to the preferred embodiment of the present invention.

The first operative unit 20 includes a first handle 27, a connective portion 24 pivotally connected to the first handle 27, and a first jaw 22 formed on the connective portion 24. The first handle 27 extends substantially perpendicular to the first jaw 22. The first jaw 22 includes a striking face 28 formed at a first end, an inclined face 29 formed at a second end, a catch 26 formed near the inclined face 29, and two grooves 12 made in two lateral portions near the catch 26. The catch 26 includes a recess 25 made in a lower face.

The second operative unit 30 includes a second handle 31, a connective portion (not numbered) formed on the second handle 31, a second jaw 32 formed on the connective portion thereof, and an aperture 37 made between the connective portion thereof and the second jaw 32. The second handle 31 extends substantially perpendicular to the second jaw 32. The aperture 34 is a ∞-shaped aperture that includes two portions for reasons to be given later. The second jaw 32 includes a catch 36 formed at an end. The catch 36 is shaped corresponding to the catch 26. The catch 36 includes a recess 38 made in a lower face. The recess 38 is shaped corresponding to the recess 25.

A pivot 21 includes a portion inserted in the connective portion 24 and another portion inserted in a selected one of the portions of the aperture 34. Thus, the second operative unit 20 is pivotally connected to the second operative unit 30. Furthermore, the pivot 21 is inserted in a washer 16. The pivot 21 can be a rivet for example. The first jaw 22 and the connective portion 24 together provide a space for receiving the second jaw 32.

A torsion spring 14 is formed with two ends 18. One of the ends 18 hooks a rivet attached to the first handle 27 while the other end 18 hooks a rivet attached to the second handle 31. Thus, the operative units 20 and 30 are normally opened.

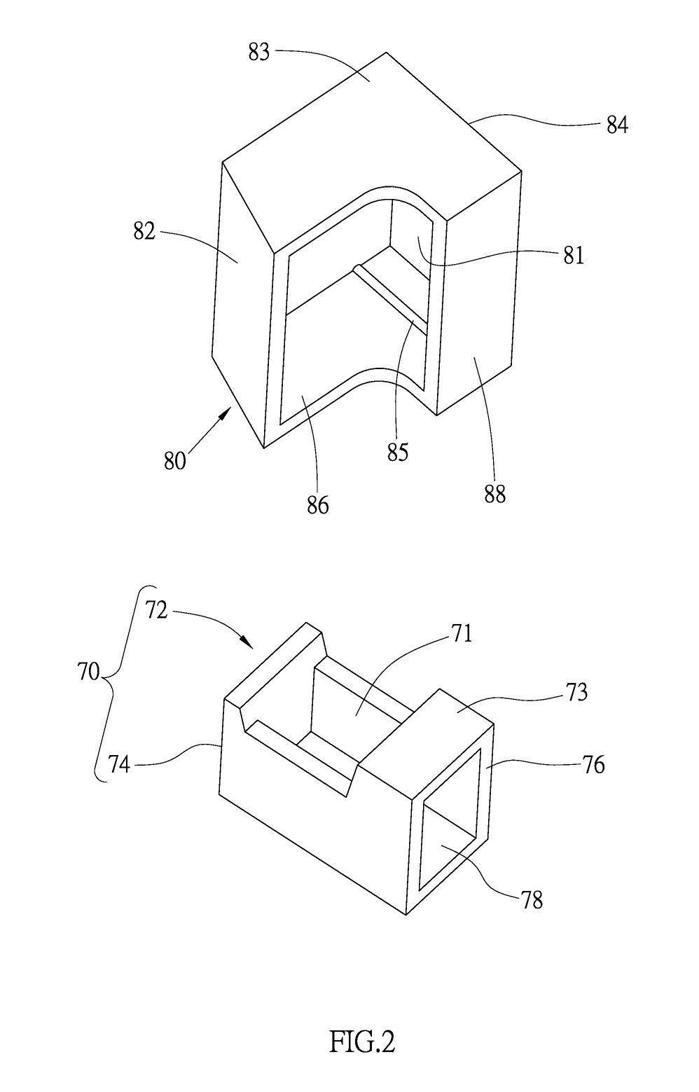

Referring to FIG. 2, the rim-protecting assembly 70 includes a first protective cap 80 and a second protective cap 72. The first protective cap 80 includes a first end 82, a second end 84, two lateral portions 83 formed between the ends 82 and 84, and a lower portion 88 formed between the ends 82 and 84. The first end 82 is a closed end. The first protective cap 80 further includes an opening 86 with a portion made in the first end 82 and another portion made in the lower portion 88. The first protective cap 80 further includes an entrance 81 made in the second end 84. Each of the lateral portions 83 includes a rib 85 formed on an internal face.

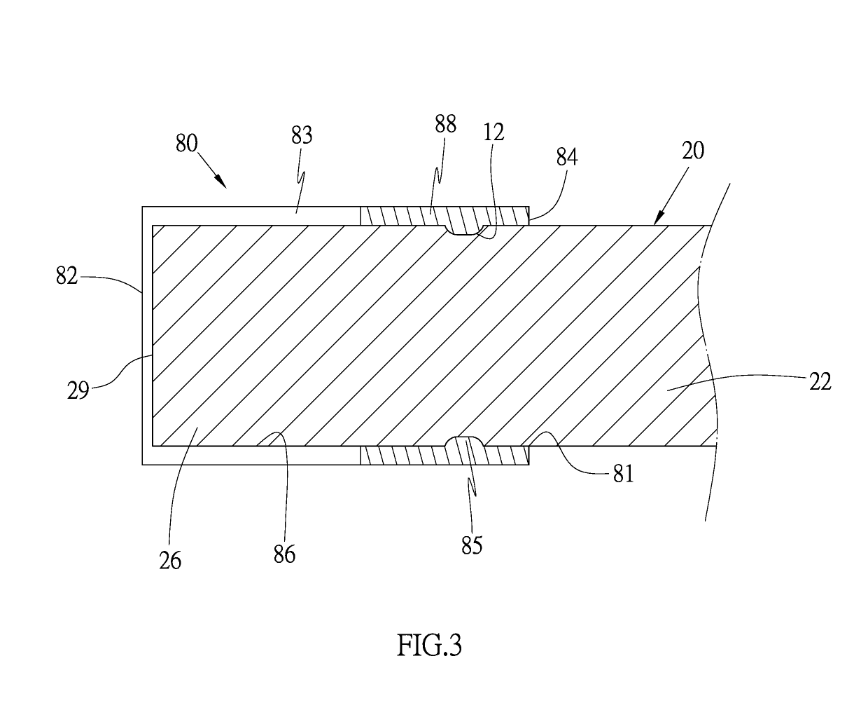

Referring to FIGS. 1 to 3, the first protective cap 80 is provided on the first jaw 22 as the second end of the first jaw 22 is inserted in the first protective cap 80 via the entrance 81. The first end 82 is placed against the second end of the first jaw 22. The lateral portions 83 are placed against two lateral portions of the catch 26. The lower portion 88 is placed against a lower portion of the catch 26. The ribs 85 are inserted in the grooves 12 to keep the first protective cap 80 on the catch 26. The second end of the first jaw 22 and the catch 26 are exposed via the opening 86.

The second protective cap 72 includes a first end 74, a second end 76, and an upper portion 73 formed between the ends 74 and 76. The first end 74 of the second projective cap 72 is a closed end. An entrance 78 is made in the second end 76 of the second projective cap 72. The upper portion 73 of the second projective cap 72 is made with an opening 71.

The second protective cap 72 is provided on the second jaw 32 when the end of the second jaw 32 is inserted in the second protective cap 72 via the entrance 78. The first end 74 is placed against the end of the second jaw 32. The catch 36 is exposed through the opening 71. The second protective cap 72 covers the end of the second jaw 32 except the catch 36.

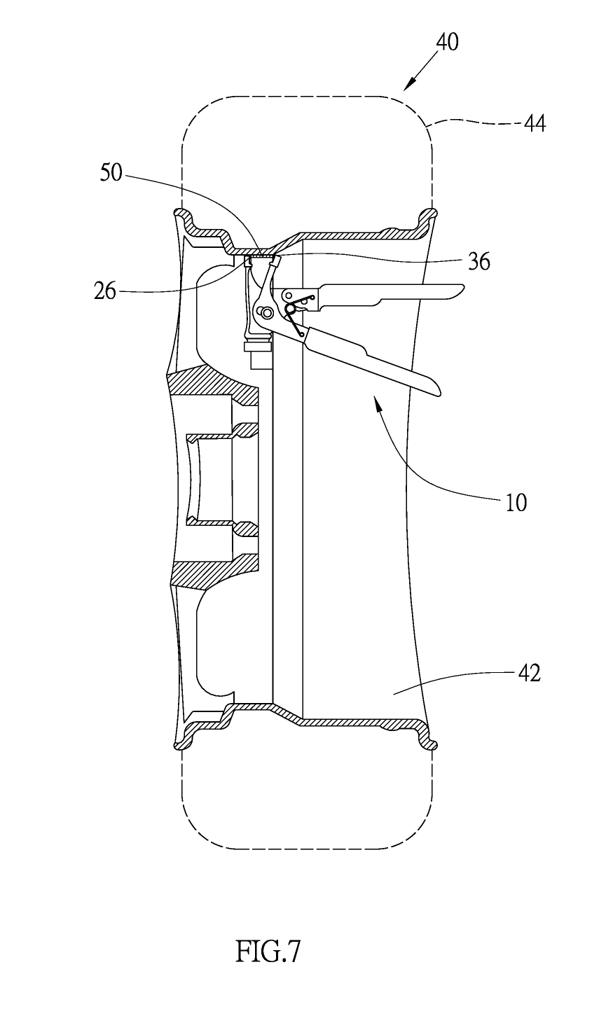

Referring to FIG. 7, there is a wheel 40 including a tire 44 supported on a rim 42. The scratch-proof pair of pliers 10 is used to remove an adhering-type weight 50 from the rim 42. The catches 26 and 36 are engaged with the weight 50 while the other portion of the second end of the first jaw 22 and the other portion of the end of the second jaw 30 are covered by the protective caps 80 and 72. Thus, the other portion of the second end of the first jaw 22 and the other portion of the end of the second jaw 30 are kept from the rim 42 so that there will be no scratching.

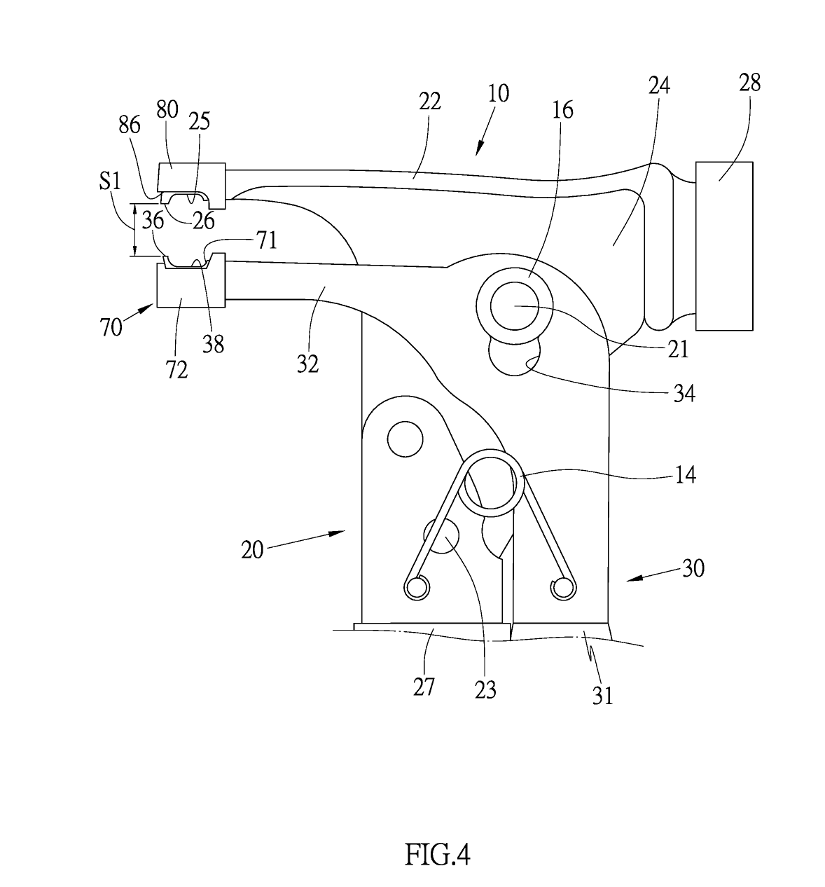

Referring to FIG. 4, the pivot 21 is inserted in the first portion of the aperture 34. There is a distance S1 between the catches 26 and 36 as the handles 27 and 31 are closed.

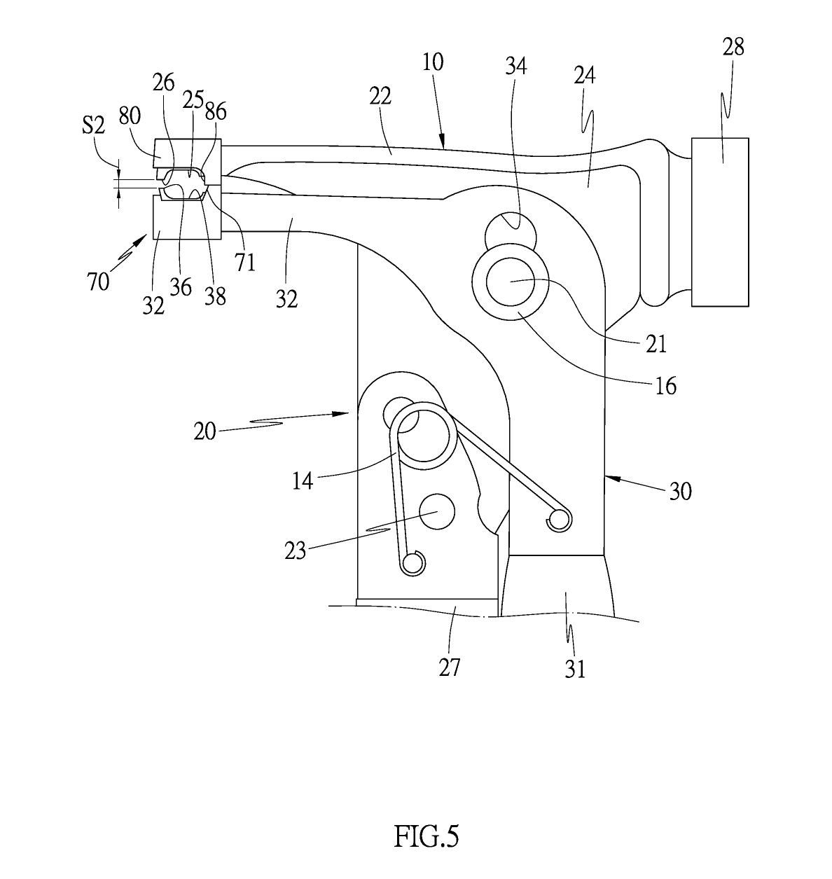

Referring to FIG. 5, the pivot 21 is inserted in the second portion of the aperture 34. There is a distance S2 between the catches 26 and 36 as the handles 27 and 31 are closed.

The distance S1 is larger than the distance S2. The scratch-proof pair of pliers 10 is hence suitable for removing larger weights when the pivot 21 is in the position shown in FIG. 4 than when the pivot 21 is in the position shown in FIG. 5.

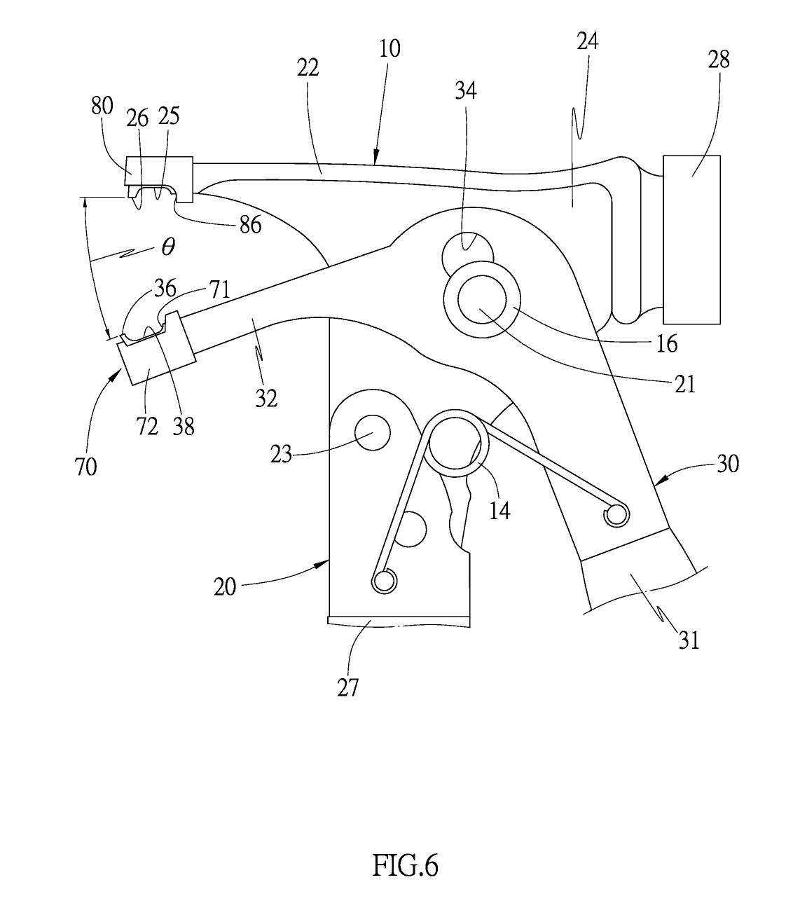

Referring to FIG. 6, the pivot 21 is inserted in the second portion of the aperture 34. There is an angle θ between the catches 26 and 36 when the handles 27 and 31 are opened by the torsion spring 14.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A scratch-proof pair of pliers comprising:
a first operative unit comprising an end formed thereon and a first catch formed near the end, wherein the first catch is adapted for engagement with a portion of a weight;
a second operative unit comprising an end formed thereon and a second catch formed near the end thereof, wherein the second catch is adapted for engagement with another portion of the weight; and
a first protective cap comprising:
a first end;
a second end;
a lower portion formed between the first and second ends;
an entrance made in the second end; and
an opening comprising a portion made in the first end and another portion made in the lower portion, wherein the first protective cap is provided on the end of the first operative unit while the catch of the first operative unit is exposed via the opening.

2. The scratch-proof pair of pliers according to claim 1, wherein the first operative unit comprises at least one groove made therein, wherein the first protective cap comprises at least one rib inserted in the groove to keep the first protective cap on the first operative unit.

3. The scratch-proof pair of pliers according to claim 1, further comprising a second protective cap comprising:
a first end; a second end;
an upper portion formed between the first and second ends thereof;
an entrance made in the second end thereof; and
an opening made in the upper portion, wherein the second protective cap is provided on the second operative unit near the catch as an end of the second operative unit is inserted in the second protective cap via the entrance, wherein the catch is exposed through the opening of the second protective cap and adapted for engagement with a weight.

4. The scratch-proof pair of pliers according to claim 3, wherein the first end is a closed end.

5. The scratch-proof pair of pliers according to claim 4, wherein the first end of the second protective cap is placed against the second operative unit near the catch.

6. The scratch-proof pair of pliers according to claim 1, wherein the first operative unit comprises an inclined face formed at the end thereof and partially exposed from the opening.
